(19) United States
(12) Patent Application Publication
(10) Pub. No.: US 2008/0080798 A1
(43) Pub. Date: Apr. 3, 2008

(54) BEARING FIXING STRUCTURES AND METHODS OF FIXING BEARINGS

(75) Inventors: Hideki ASANO, Obu-shi (JP); Hiroshi ASANUMA, Obu-shi (JP); Tetsushi NATSUME, Kariya-shi (JP)

Correspondence Address: DENNISON, SCHULTZ & MACDONALD, 1727 KING STREET, SUITE 105, ALEXANDRIA, VA, 22314, US

(73) Assignees: AISAN KOGYO KABUSHIKI KAISHA, Obu-shi (JP); DENSO CORPORATION, Kariya-shi (JP)

(21) Appl. No.: 11/859,051

(22) Filed: Sep. 21, 2007

(30) Foreign Application Priority Data
Sep. 28, 2006 (JP) 2006-264404

(51) Int. Cl. F16C 35/00; B23P 11/00

(52) U.S. Cl. 384/441; 29/447

(57) ABSTRACT

The present invention includes a bearing fixing structure for fixing a bearing in position relative to a resin housing. The bearing is fitted into an inner circumference of the housing. The structure includes an annular holding member and an engaging device. The holding member is press-fitted into the inner circumference of the housing so as to hold the bearing from one side with respect to an axial direction of the housing for preventing the bearing from being removed from the housing. The engaging device engages an outer circumferential face of the holding member with the inner circumference of the housing with respect to the axial direction of the housing.

This application claims priority to Japanese patent application serial number 2006-264404, the contents of which are incorporated herein by reference.

### BACKGROUND OF THE INVENTION

1. Field of the Invention

The present invention relates to structures and methods for fixing bearings within resin housings. The bearings can rotatably support shafts.

2. Description of the Related Art

Japanese Laid-Open Utility Model Publication No. 2-18630 teaches a known bearing fixing structure, which is shown in FIG. 10. As shown in FIG. 10, a bearing 100 is fixed in position relative to a housing 110 by press-fitting the bearing 100 into a cylindrical press-fitting portion 112 of the housing 110. The housing 110 is molded using a die. A ring-shaped holding member 115 is also press-fitted into the press-fitting portion 115 and holds the bearing 100 from its axially outer side for preventing the bearing 100 from being removed

However, for example, if the housing 110 is made of resin, fixing the bearing 100 and the holding member 115 in position by press-fitting these elements into the cylindrical press-fitting portion 112 in a usual manner sometime results in the bearing 100 and the holding member 115 are removed due to deformation of the cylindrical press-fitting portion 112, which may be caused during a long time of use. For this reason, a press-fitting allowance for the holding member 115 may be set for ensuring the prevention of the holding member 115 from being removed. However, this setting is not preferable, because this may cause breakage of the press-fitting portion 112 in some cases.

Therefore, there is a need in the art for a technique that enables a bearing to be firmly fixed within a resin housing without causing potential removal of the bearing from the housing during a long time of use.

### SUMMARY OF THE INVENTION

A bearing fixing structure includes a holding member for holding a bearing in position within a resin housing. The holding member engages the inner circumference of the housing via convex shapes or grooves. The holding member can be press-fitted into the housing or may be fitted into the housing by using resilient deformation. The holding member can be replaced with a clamp member that applies a clamping force against the housing, so that the housing can be forced to be pressed against the bearing.

### BRIEF DESCRIPTION OF THE DRAWINGS

FIG. 1 is a horizontal sectional view of a throttle control device incorporating a bearing fixing structure according to an embodiment of the present invention;

FIG. 2 is vertical sectional view of the bearing fixing structure;

FIG. 3(A) is a partial cross sectional side view of a holding member of the bearing fixing structure;

FIG. 3(B) is a rear view of the holding member as viewed in a direction indicated by arrows B-B in FIG. 3(A);

FIG. 3(C) is a cross sectional view taken along line C-C in FIG. 3(A);

FIG. 4(A) is a vertical sectional view of a bearing fixing structure according to another embodiment of the present invention;

FIG. 4(B) is a front view of a holding member in a constricted state of the bearing fixing structure;

FIG. 4(C) is a front view of the holding member in an enlarged state;

FIG. 4(D) is a front view of the bearing fixing structure;

FIG. 5 is a front view of a bearing fixing structure according to a modification of the embodiment shown in FIGS. 4(A) to 4(D);

FIGS. 6(A), 6(B), 6(C) and 6(D) are vertical sectional views showing different bearing fixing structures according to a further embodiment of the present invention;

FIGS. 7(A) and 7(B) are front views of the bearing fixing structures according to the embodiment shown in FIGS. 6(A) to 6(D) and showing different configurations of clamping members;

FIG. 8 is a side view of a clamping member of a bearing fixing structure according to a further embodiment of the present invention;

FIG. 9(A) is a side view of an alternative clamping member;

FIG. 9(B) is a cross sectional view taken along line B-B in FIG. 9(A); and

FIG. 10 is a vertical sectional view of a known bearing fixing structure.

### DETAILED DESCRIPTION OF THE INVENTION

Each of the additional features and teachings disclosed above and below may be utilized separately or in conjunction with other features and teachings to provide improved bearing fixing structures and methods of fixing bearings. Representative examples of the present invention, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment of a structure for fixing a bearing in position within a resin housing, the structure includes an annular holding member and an engaging device. The holding member is press-fitted into the inner circumference of the housing so as to hold the bearing from one side with respect to an axial direction of the housing for preventing the bearing from being removed from the housing. The engaging device engages an outer circumferential face of the holding member with the inner circumference of the housing with respect to the axial direction of the housing.

Therefore, as the annular holding member is press-fitted into the housing, the outer circumferential face of the holding member engages with the inner circumference of the housing. Hence, even if the inner circumference of the housing has been deformed, the holding member can be reliably held so as to not to move in the axial direction. As a result, the bearing can be reliably prevented from being removed from the housing.

The engaging device can include at least one convex portion provided on the outer circumferential face of the holding member. The at least one convex portion can bite or press into the inner circumference of the housing. Therefore, the holding member can be reliably held in position.

The at least one convex portion can include a plurality of ridges extending obliquely relative to a central axis of the holding member and arranged in a circumferential direction of the holding member.

With this arrangement, as the annular holding member is press-fitted into the housing, the holding member rotates about its axis while the holding member advances in the axial direction. Thus, the ridges serve to cause rotation of the holding member. Therefore, the ridges provided on the outer circumferential face of the holding member do no interfere with the press-fitting operation of the holding member. In addition, due to the function of the ridges, the holding member is press-fitted into the housing in a manner like a screw that is threaded into the holding. Therefore, even if the inner circumference of the housing has been deformed, the holding member can be reliably held not to move in the axial direction. As a result, the bearing can be reliably prevented from being removed from the housing during a long time use.

Alternatively, the engaging device can include at least one concave portion provided on the outer circumferential face of the holding member. The inner circumference of the housing can press into the at least one concave portion. Because no convex portion is provided on the outer circumferential face of the holding member, the operation for press-fitting the holding member into the housing can be smoothly performed.

The at least one concave portion can include a plurality of grooves formed in the outer circumferential face of the holding member. The plurality of grooves extend obliquely relative to a central axis of the holding member and are arranged in a circumferential direction of the holding member.

Alternatively, the at least one concave portion can be at least one radial hole extending radially inward from the outer circumferential face of the holding member.

The present invention can also include an embodiment for a method of fixing a bearing in position within a resin housing includes the steps of preparing a holding member having an outer circumferential face and having at least one convex portion or at least one concave portion provided on the outer circumferential face, heating the holding member, and press-fitting the heated holding member into the inner circumference of the housing and holding the bearing from one side with respect to an axial direction of the housing, so that the inner circumference of the housing is plasticized or softened by the heat and the at least one convex portion or the at least one concave portion engages the inner circumference of the housing.

Because the holding member is press-fitted into the housing on the condition that the holding member is heated, the inner circumference of the housing is softened by the heat of the holding member and therefore conform to the configuration of the outer circumferential face of the holding member. Therefore, the outer circumferential face of the holding member can reliably engage with inner circumference of the housing. As a result, the holding member can be reliably prevented from being removed from the housing.

Another embodiment of a method of fixing a bearing in position within a resin housing according to the present invention includes the steps of preparing a holding member having an outer diameter and resiliently deformable to vary the outer diameter, heating the holding member, forcing the holding member to resiliently reduce the outer diameter and fitting the holding member into the housing, so that the holding member is position to hold the bearing from one side with respect to an axial direction of the housing, and permitting the holding member to resiliently enlarging the outer diameter, so that the inner circumference of the housing is softened by the heat of the holding member and the holding member presses into the inner circumference of the housing.

Because the holding member is fitted into the housing while the outer diameter of the holding member is reduced, it is possible to easily fit the holding member into the housing in comparison with the case where the holding member is press-fitted into the housing. In addition, the heated holding member resiliently enlarges and presses into the inner circumference of the housing, the holding member can be easily fixed in position relative to the housing and the holding member can be reliably prevented from being removed.

A further embodiment of a method of fixing a bearing in position within a resin housing according to the present invention includes the steps of preparing a holding member having an arc-shaped configuration and having an outer diameter smaller than a diameter of the inner circumference of the housing, heating the holding member, fitting the holding member into the housing, so that the holding member is position to hold the bearing from one side with respect to an axial direction of the housing, moving the holding member in a direction radially outward with respect to the housing, so that the inner circumference of the housing is softened by the heat of the holding member and the holding member presses into the inner circumference of the housing.

Because the arc-shaped holding member having the outer diameter smaller than the diameter of the inner circumference of the housing is fitted into the housing, it is possible to easily fit the holding member into the housing in comparison with the case where the holding member is press-fitted into the housing. In addition, because the heated holding member is moved radially outward and presses into the inner circumference of the housing, the holding member can be easily fixed in position relative to the housing and the holding member can be reliably prevented from being removed.

A further embodiment of a structure for fixing a bearing in position within a resin housing includes a clamp member constructed to clamp the housing in such a direction that a diameter of the inner circumference of the housing is reduced, so that the bearing is prevented from being removed from the housing.

With this arrangement, it is possible to effectively prevent the bearing from being removed in particular in the case that the housing has a small thickness in the radial direction.

The housing can be opened at one end, and the clamp member can be positioned on the side of the one end of the housing with respect to the bearing. In another embodiment, the clamp member is resiliently deformable, so that the clamping member clamps the housing by a resilient force. In an alternative, the clamp member has a tubular configuration having an inner diameter smaller than a diameter of an outer circumference of the housing. The clamp member is fitted onto the housing, so that the clamp member clamps the outer circumference of the housing from the outer side.

A still further embodiment of a method of fixing a bearing in position within a resin housing according to the present invention includes the steps of preparing a clamp member having a tubular configuration, heating the holding member, so that the clamp member is enlarged, fitting the enlarged clamp member onto an outer circumference of the housing, and permitting the heat of the clamp member to be dissipated, so that the clamp member constricts and clamps the housing from the outer side for preventing the bearing from being removed from the housing.

Because the tubular clamp member is heated to enlarge and is then fitted onto the outer circumference of the housing, the fitting operation of the clamp member can be easily performed. In addition, because the clamp member constricts due to dissipation of the heat, it is possible to effectively clamp the housing from the outer side.

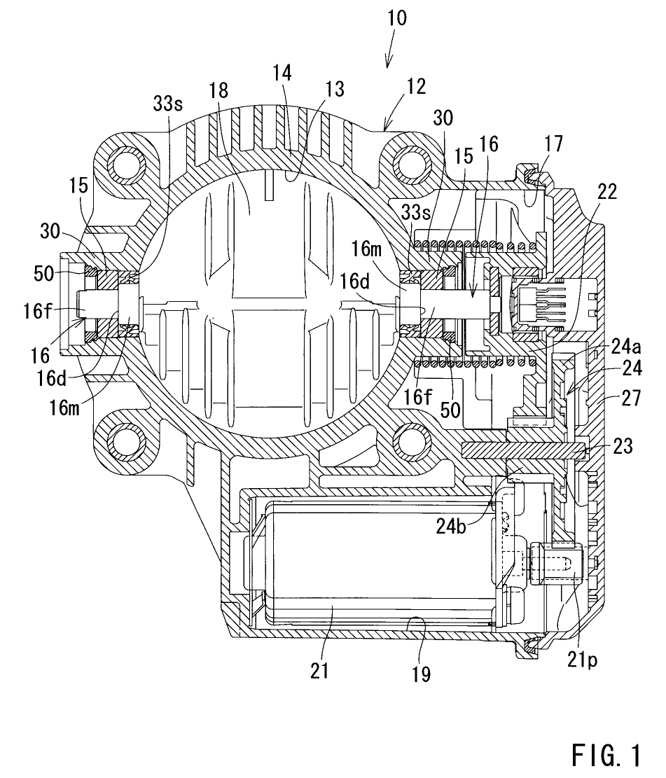

Various embodiments according to the present invention will now be described. A bearing fixing structure according to an embodiment of the present invention will be first described with reference to FIGS. 1, 2, 3(A), 3(B) and 3(C).

A throttle control device 10 incorporating the bearing fixing structure according to this embodiment will now be first briefly described. The throttle control device 10 is configured as an electronic control device for controlling the flow of intake air that is supplied to an engine (not shown). The control device is operable in response to the operation of an accelerator pedal that may be located in a driver's cabin of an automobile (not shown).

The throttle control device 10 has a throttle body 12 that can be made of resin, such as PPS (polyphenylene sulfide). As shown in FIG. 1, the throttle body 12 includes a hollow cylindrical tubular bore wall portion 14, a throttle gear housing 17 and a motor housing 19, which can be formed integrally with each other. The bore wall portion 14 defines a bore 13 through which the intake air can flow. An air cleaner (not shown) is connected to an upstream-side (front side of the sheet of FIG. 1) of the bore wall portion 14. An intake manifold (not shown) is connected to a downstream-side (backside of the sheet of FIG. 1) of the bore wall portion 14. A circular disk-like throttle valve 18 is disposed within the bore 13 and is rotatable about a central axis for controlling the passage area of the bore 13 for the flow of the intake air. The throttle valve 18 has right and left shaft portions 16, which are respectively disposed on right and left sides of the throttle valve 18 and extend along the central axis of the throttle valve 18.

Each of the shaft portions 16 has a base end portion 16m and a shaft body 16f having the same axis as the base end portion 16m. The base end portion 16m is disposed on the side of the throttle valve 18 and has a diameter larger than a diameter of the shaft body 16f, so that a stepped portion 16d defining an annular face is formed between the base end portion 16m and the shaft body 16f. An oil seal 33s is fitted around the base end portion 16m of each of the shaft portions 16 in order to seal the interior of the bore 13 from the outside environment. The bore wall portion 14 has bearing support portions 30 that respectively support the shaft bodies 16f of the shaft portions 16.

Right and left bearings 15 are configured to be fixed to the respective bearing support portions 30 by press-fitting. As will be described later, after the bearings 15 have been press-fitted, holding members 50 are positioned to oppose to the end faces of the bearings 15 from the axially outer side, so that the bearings 15 can be prevented from being removed from the respective support portions 30.

The shaft body 16f of the shaft portion 16 disposed on the left side of the throttle valve 18 extends through the corresponding bearing 15 and into the corresponding bearing support portion 30 of the bore wall portion 14. The shaft body 16f of the shaft portion 16 disposed on the right side of the throttle valve 18 extends through the corresponding bearing 15 and into the corresponding bearing support portion 30 of the bore wall portion 14 and further into the throttle gear housing 17. The throttle gear housing 17 houses a throttle gear 22 configured as a sector gear. The throttle gear housing 17 is disposed on the right side of the bore wall portion 14 to surround the right side bearing support portion 30 of the bore wall portion 14. Within the throttle gear housing 17, the throttle gear 22 is disposed coaxially with the shaft portions 16 of the throttle valve 18 and is coupled to the right protruding end of the right shaft portion 16. The throttle gear 22 is prevented from rotating relative to the right shaft portion 16 (i.e., the shaft body 16f).

The motor housing 19 of the throttle body 12 is adapted to house a motor 21, such as a DC motor, and has a longitudinal axis that is parallel to the shaft portions 16 of the throttle valve 18. The motor housing 19 has a cylindrical tubular configuration with a bottom.

A countershaft 23 is mounted to the throttle body 12 in a position between the throttle gear housing 17 and the motor housing 19 and rotatably supports a counter gear 24. The counter gear 24 has a large-diameter gear portion 24a and a small-diameter gear portion 24b. The large-diameter gear portion 24a is in engagement with a motor pinion 21p of the motor 21. The small-diameter gear portion 24b is in engagement with the throttle gear 22. Therefore, when the motor 21 is driven based on a signal from an engine control unit (not shown) by an amount corresponding to the stepping amount of the accelerator pedal, the rotational torque of the motor 21 is transmitted to the right shaft portion 16 of the throttle valve 18 via the motor pinion 21p, the counter gear 24 and the throttle gear 22. Hence, the throttle valve 18 rotates within the bore 13 to control the amount of flow of the intake air that flows through the bore 13.

A cover 27 is attached to the throttle body 12 for closing the openings of the throttle gear housing 17 and the motor housing 19 of the throttle body 12. The attaching operation of the cover 27 is made after the motor pinion 21p, the counter gear 24 and the throttle gear 22, etc., have been assembled.

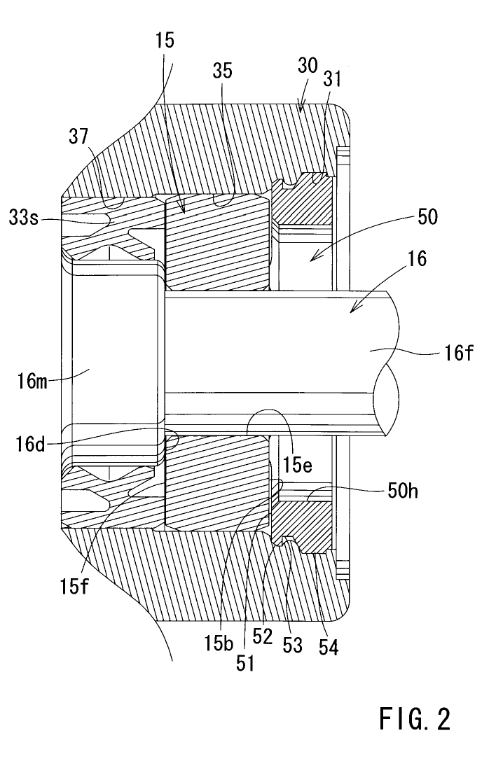

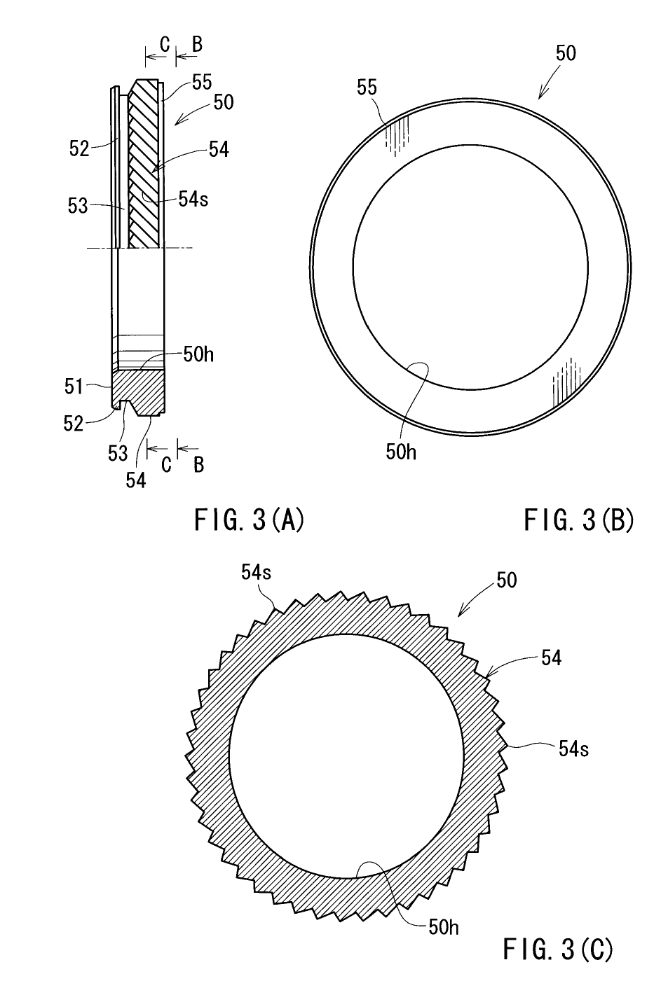

The bearing fixing structure will now be described with reference to FIGS. 2 and 3. Because the fixing structures of the right and left bearings 15, as well as the configurations of the right and left bearings 15, are the same with each other, only the fixing structure and the configuration of the right bearing 15 will be described. The right bearing 15 is configured as a ring-shaped slide bearing and has a substantially rectangular configuration in cross section as shown in FIG. 2. The diameter of an inner circumferential face 15e of the bearing 15 is determined such that a predetermined clearance is provided between the inner circumferential face 15e and the shaft body 16f of the corresponding shaft portion 16 of the throttle valve 18.

As shown in FIG. 2, the support portion 30 of the bore wall portion 14, into which the bearing 15 is press-fitted, has a substantially cylindrical tubular configuration. A first fitting region 31 for the holding member 50, a second fitting region 35 for the bearing 15 and a seal receiving region 37 are in turn coaxially formed in an inner circumferential wall of the support portion 30 along an axial direction from a front end on the side opposite to the throttle valve 18 of the inner circumferential wall.

The first fitting region 31, into which the holding member 50 is press-fitted, has a diameter smaller than the outer diameter of the holding member 50 by a predetermined size. The second fitting region 35 is positioned on the backside of the first fitting region 31 and has a diameter smaller than the diameter of the first fitting region 31 by a predetermined size. The first fitting region 31, into which the bearing 15 is press-fitted, has a diameter smaller than the outer diameter of the bearing 15 by a predetermined size. The seal receiving region 37 is positioned on the backside of the second fitting region 35 and serves to receive a ring-shaped oil seal 33s. The first fitting region 31 for the holding member 50 and the second fitting region 35 for the bearing 15 are positioned to correspond to the shaft body 16f of the corresponding shaft portion 16 with respect to the axial direction. The seal receiving region 37 is positioned to correspond to the base end 16m of the shaft portion 16 with respect to the axial direction.

The holding member 50 is press-fitted into the first fitting region 31 of the corresponding bearing support portion 30 after the bearing 15 has been press-fitted into the second fitting region 35. Hence, the holding member 50 serves to prevent the bearing 15 from being removed from the bearing support portion 30. As shown in FIG. 3, the holding member 50 is molded to have a ring-shaped configuration. A flat front end face 51 of the holding member 50 is adapted to be pressed against the outer circumferential edge of a rear end face 15b of the bearing 15 (see FIG. 2). In this embodiment, the outer diameter of the holding member 50 is set to be larger than the outer diameter of the bearing 15, while the inner diameter of a central opening 50h of the holding member 50 is set to be smaller than the outer diameter of the bearing 15. The inner diameter of the central opening 50h may have any diameter value as long as the holding member 50 does not contact with the shaft portion 16.

On the outer circumferential face of the holding member 50, a projecting portion 52, a V-shaped recess portion 53, a concave-convex portion 54 and a corner recess portion 55 are in turn coaxially formed along the axial direction from the front side. The projecting portion 52 is positioned at the front end of the holding member 50 and extends along its entire circumference. The outer circumference of the projecting portion 52 is forwardly tapered. The V-shaped recess portion 53 is configured to define a V-shaped recess in cross section, which is positioned on the rear side of the projecting portion 52 and extends along the entire circumference of the holding member 50. One of the axially opposing walls of the V-shaped recess portion 53 on the side of the projecting portion 52 extends within a vertical plane that is perpendicular to the central axis of the holding member 50. The other of the axially opposing walls of the V-shaped recess portion 53 on the side of the concave-convex portion 54 is inclined relative to the vertical plane.

The concave-convex portion 54 tends to press deeper (than the other regions of the holding member 50) into the inner circumferential face of the first fitting region 31 of the bearing support portion 30 when the holding member 50 is press-fitted into the first fitting region 31. The concave-convex portion 54 has a plurality of ridges 54s arranged along the circumferential direction. The ridges 54s extend parallel to each other and obliquely relative to the central axis of the holding member 50. As shown in FIG. 3(C), each of the ridges 54s has a substantially triangular configuration in cross section within a plane perpendicular to the central axis of the holding member 50.

Therefore, as the holding member 50 is press-fitted into the first fitting region 31 of the inner circumference of the bearing support portion 30, the ridges 54s may press or bite into the inner circumferential face of the first fitting region 31, so that the holding member 50 advances axially as it rotates about the central axis. The projecting portion 52 and the ridges 54s of the concave-convex portion 52 of the holding member 50 may be collectively referred to as “convex portions.”

The press-fitting operations of the right and left bearings 15 and the corresponding holding members 50 may be performed according to the following process. First, the oil seals 33s are fitted between the base end portions 16m of the shaft portions 16 and the seal receiving regions 37 of the corresponding bearing support portions 30 (see FIG. 2) in the state where the throttle valve 18 is received within the bore 13 of the throttle body 12 and the right and left shaft portions 16 are inserted into the respective support portions 30 of the bore wall portion 14. Subsequently, the bearings 15 are fitted onto the shaft bodies 16f of the corresponding shaft portions 16. Thereafter, with the shaft bodies 16f of the shaft portions 16 inserted into the respective bearings 15, the bearings 15 are moved axially toward each other (toward the throttle valve 18) so as to be press-fitted into the second fitting regions 35 of the corresponding support portions 30. Each bearing 15 is press-fitted into the corresponding second fitting region 35 until the front end face 15f of the bearing 15 abuts to the stepped portion 15d of the corresponding shaft portion 16.

Next, the holding members 50 are heated to a temperature of about 350° C. and are then press-fitted into the first fitting regions 31 of the corresponding bearing support portions 30, so that the ridges 54s formed on the outer circumferences of the holding members 50 may press into the inner circumferences of the first fitting regions 31, while the holding members 50 rotate about their axes. The press-fitting operation of each holding member 50 may be completed when the flat end face 51 abuts to the rear end face 15b of the corresponding bearing 15. As the press-fitting operation is thus completed, a part of the inner circumferential face of the first fitting region 31 is softened or plasticized by the heat of the corresponding holding member 50 and may enter the V-shaped recess defined by the V-shaped recess portion 53 of the holding member 50. The softened part of the holding member 50 may also enter the trough defined between each two adjacent ridges 54s and the recessed corner portion 55.

According to the bearing fixing structure of this embodiment, convex portions including the projecting portion 52 and the ridges 54s of the convex-concave portion 54 are formed on the outer circumferential face of each holding member 50 that serves to axially hold the corresponding bearing 15 at its rear end face 15b. Therefore, in the state where the holding member 50 has been press-fitted into the first fitting region 31 of the corresponding bearing support portion 30 and the projecting portion 52 and the ridges 54 have pressed into the inner circumference of the first fitting region 31, the holding member 50 can be reliably held not to move in the axial direction relative to the corresponding bearing support portion 30 by the function of the projecting portion 52 and the ridges 54, even in the event the first fitting region 31 of the bearing support portion 30 has deformed as time passes. Therefore, the holding member 50 can reliably prevent the bearing 15 from being removed from the bearing support portion 30.

In addition, as the holding member 50 is press-fitted into the first fitting region 31 of the bearing support portion 30, the ridges 54s press into the inner circumference of the first fitting region 31, while the holding member 50 rotates about its axis. Therefore, although a number of ridges 54s are formed on the outer circumference of the holding member 50, the ridges 54s do not substantially prevent or resist against the press-fitting operation of the holding member 50. Further, because the holding member 50 is press-fitted into the bearing support portion 30 in a manner like a screw due to the action of the ridges 54s, it is possible to further reliably prevent the bearing 15 from being removed from the bearing support portion 30, even in the event the first fitting region 31 of the bearing support portion 30 has deformed as time passes.

Further, because the holding member 50 is press-fitted into the first fitting region 31 of the bearing support portion 3 after the holding member 50 has been heated, the inner circumference of the first fitting region 31 may be softened by heat, facilitating the ridges 54s of the holding member 50 to press into the inner circumference of the first fitting region 31. As a result, the holding member 50 may be further reliably prevented from being removed.

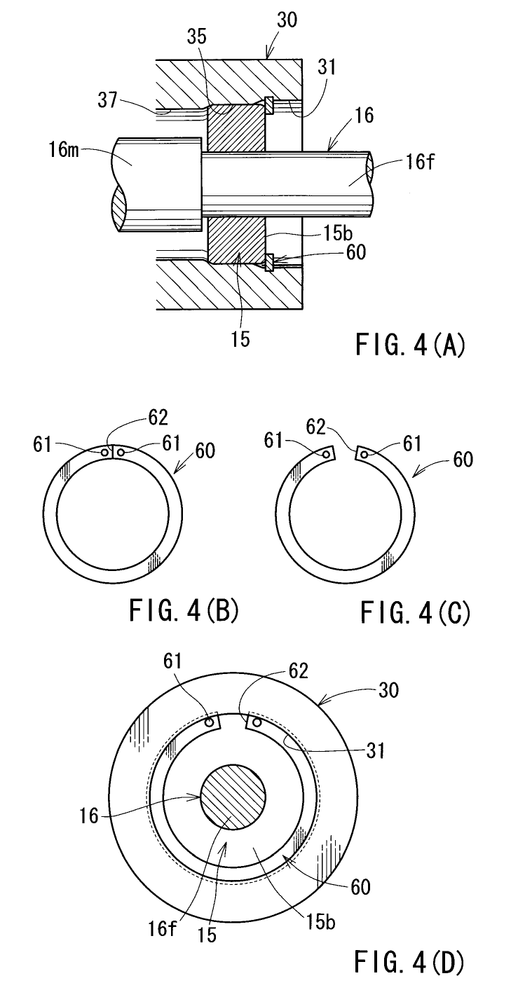

Other various embodiments will now be described with reference to FIGS. 4(A), 4(B), 4(C) and 4(D) to FIGS. 9(A) and 9(B). These embodiments are modifications of the first embodiment. Therefore, like members are given the same reference numerals as the first embodiment and the description of these members will not be repeated.

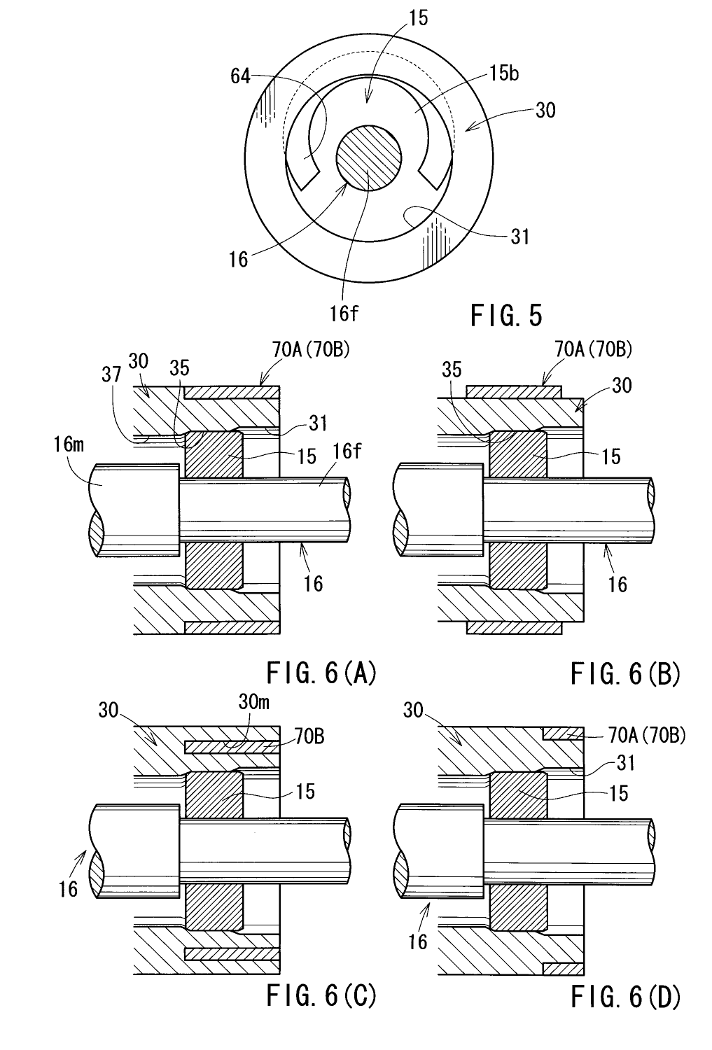

The embodiment shown in FIGS. 4(A), 4(B), 4(C), 4(D) and 5 will now be described. This embodiment is different from the above embodiment only in the configuration of the holding members 50. The other construction is the same as the above embodiment.

As shown in FIGS. 4(B) and 4(C), a holding member 60 is configured as an annular leaf spring with a cut-off part 62 provided along the circumferential direction. Although only one holding member 60 for the right side bearing support member 30 is shown in the drawings, the same holding member 60 can be used also for the left bearing support member 30.

When no external force is applied, opposing circumferential ends of the holding member 60 defined by the cut-off part 62 are spaced from each other by a distance as shown in FIG. 4(C). In this state, the outer diameter of the holding member 60 is greater than the inner diameter of the first fitting region 31 of the bearing support portion 30. The outer diameter of the holding member 60 can be reduced by engaging an appropriate tool (not shown) with receiving portions 61 at the end portions of the holding member 60 and by forcing the end portions to move toward each other by the tool against the biasing force of the holding member 60, so that the end portions of the holding member 60 contact with each other as shown in FIG. 4(B). As a result, the outer diameter of the holding member 60 can be reduced to be smaller than the inner diameter of the first fitting region 31 of the bearing support portion 30.

After the bearing 15 has been press-fitted into the second fitting region 35, the holding member 60 may be fitted to the first fitting region 31 of the bearing support portion 30 according to the following process. First, the holding member 60 is heated to a predetermined temperature (e.g. about 350° C.). Then, the aforementioned tool is engaged with the receiving portions 61 of the holding member 60 and is actuated to force the end portions of the holding member 60, which are separated by the cut-off part 62, to contact with each other against the biasing force of the holding member 60, so that the diameter of the holding member 60 is reduced. Thereafter, the holding member 60 having the reduced diameter is inserted into the first fitting region 31 of the bearing support portion 30 and is held in position to contact with the rear end face 15b of the bearing 15. Then, the tool is operated to release the force applied to the holding member 60, so that the diameter of the holding member 60 is enlarged by the biasing force and the holding member 60 may press into the inner circumference of the first fitting region 31. Because the bearing support portion 30 is made of resin, the inner circumference of the first fitting region 31 may be softened by the heat of the holding member 60 (see FIGS. 4(A) and 4(D)). Finally, the tool is released from engagement with the holding member 60, so that the fitting operation of the holding member 60 is completed.

Because the holding member 60 (having the reduced diameter) is inserted into the first fitting region 31 of the bearing support portion 30, the fitting operation of the holding member 60 into the first fitting region 31 can be easily performed in comparison with a usual press-fitting operation. In addition, because the heated holding member 60 resiliently enlarges to press into the inner circumference of the first fitting region 31, it is possible to easily fix the holding member 60 in position and to reliably prevent the holding member 60 from being removed.

Although the annular holding member 60 is made of a spring material and is resiliently enlarged and constricted in this embodiment, it is possible to use a holding member 64 shown in FIG. 5, which does not have resiliency. The holding member 64 has an arc-shaped configuration and has a diameter smaller than the diameter of the first fitting region 31 of the bearing support portion 30. In this alternative embodiment, the holding member 64 is heated and is then inserted into the bearing support portion 30 to a position where the holding member 64 contacts with the rear end face 15b of the bearing 15. Thereafter, the holding member 64 is forced to move radially outward along the rear end face of the bearing 15 toward the inner circumference of the first fitting region 31, so that the holding member 64 presses into the inner circumference of the first fitting region 31.

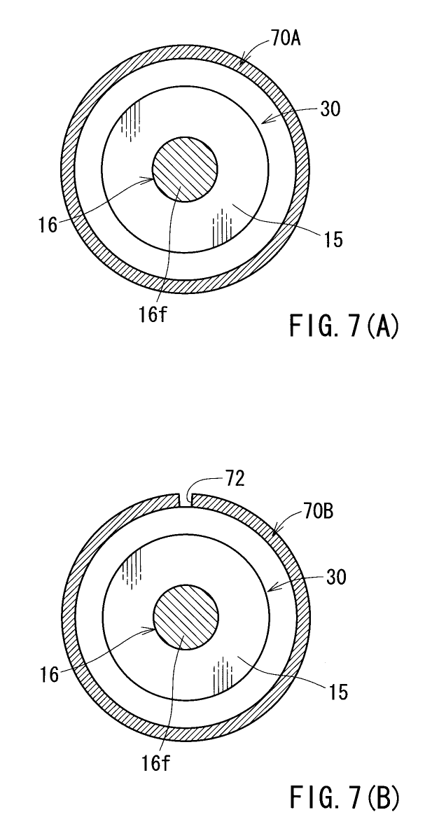

The embodiment shown in FIGS. 6(A), 6(B), 6(C), 6(D), 7(A) is different from the above embodiments only in the use of a clamp member 70A shown in FIG. 7(A) or a clamp member 70B shown in FIG. 7(B) in place of the holding members 50 and 60 of the above embodiments.

The clamp member 70A shown in FIG. 7(A) can be formed of a cylindrical metal tube. The clamp member 70B shown in FIG. 7(B) can be formed of a cylindrical metal spring with a cut-out portion 72 disposed along the circumferential direction and extending throughout the axial length of the clamp member 70B.

When the clamp member 70A shown in FIG. 7(A) is used, the clamp member 70(A) is heated so that the diameter of the clamp member 70A is enlarged. Then, the clamp member 70A is fitted onto the outer circumference of the bearing support portion 30 as shown in FIG. 6(A), 6(B) or 6(D). As the clamp member 70A is cooled by radiation of heat, the clamp member 70A constricts to decrease its diameter. Therefore, the clamp member 70A applies a clamping force against the bearing support portion 30 (including the first and second fitting regions 31 and 35) in a direction to force the bearing support portion 30 to decrease its diameter, so that the bearing 15 can be reliably prevented from being removed from the bearing support portion 30.

The clamp member 70A may be positioned to extend over a range corresponding to the first and second fitting regions 31 and 35 as shown in FIG. 6(A). Alternatively, the clamp member 70A may be positioned to primarily correspond to the second fitting region 35 as shown in FIG. 6(B) or to correspond to the first fitting region 31 as shown in FIG. 6(D).

The clamp member 70B may be resiliently enlarged as shown in FIG. 7(B) to increase a distance between opposite ends defined by the cut-out portion 72. The enlarged clamp member 70B may then be fitted onto the outer circumference of the bearing support portion 30 as shown in FIGS. 6(A), 6(B) and 6(D) or may be fitted into the bearing support portion 30 as shown in FIG. 6(C). Because the clamp member 70B resiliently constricts to reduce its diameter, the clamp member 70B applies a clamping force against the bearing support portion 30 (including the first and second fitting regions 31 and 35) in a direction for forcing the bearing support portion 30 to decrease its diameter, so that the bearing 15 can be reliably prevented from being removed from the bearing support portion 30. In the case of the arrangement of FIG. 6(C), the clamp member 70B is fitted into a tubular recess 30m formed within the bearing support portion 30. With this arrangement, the clamping force of the clamp member 70(B) can be more effectively applied to the bearing 15.

It is also possible to heat the clamp member 70B and to resiliently enlarge the clamp member 70B for increasing a distance between opposite ends defined by the cut-out portion 72 before the clamp member 70B is fitted onto the outer circumference of the bearing support portion 30.

Because the clamp member 70B having the cylindrical configuration is fitted onto the outer circumference of the bearing support portion 30, it is possible to effectively prevent the bearing 15 from being removed from the bearing support portion 30, in particular when a thickness in a radial direction of the bearing support portion 30 is small.

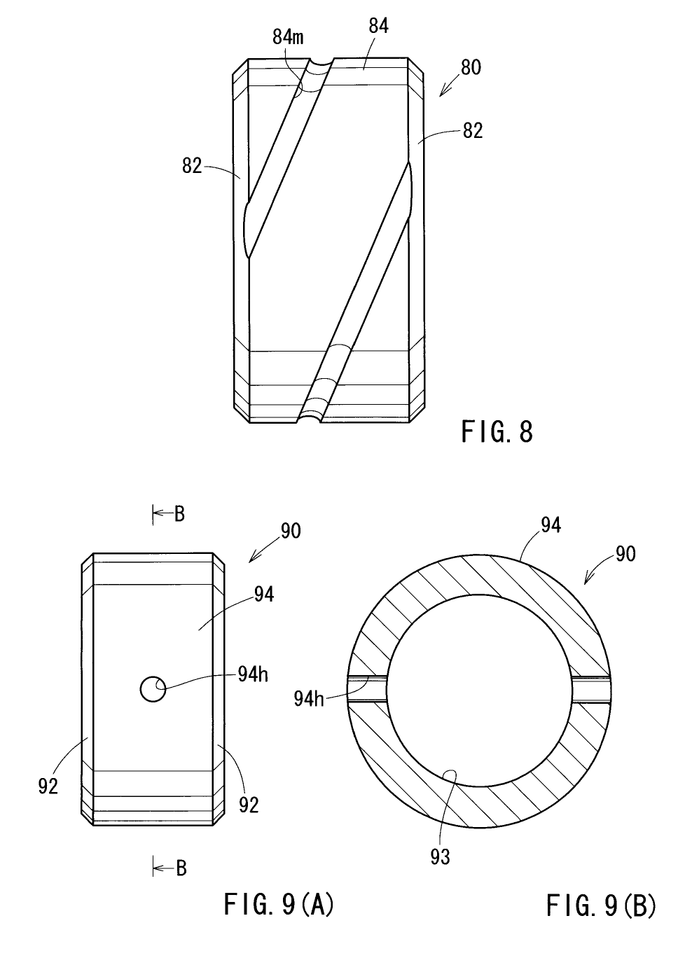

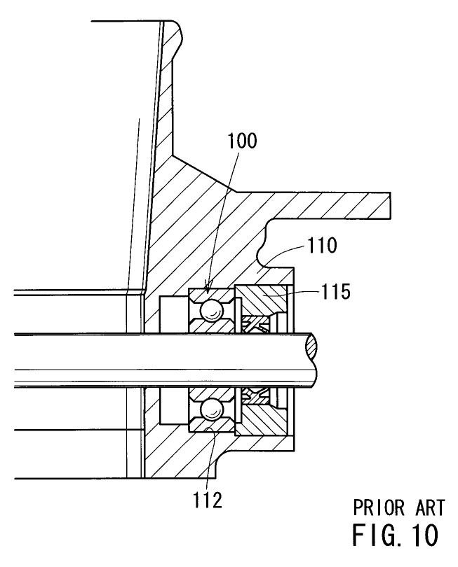

In the embodiment of shown in FIGS. 8, 9(A) and 9(B), a bearing fixing structure includes a holding member 80 that has a plurality of circumferentially spaced grooves 84m formed in an outer circumferential face 84 of the holding member 80. The grooves 84m extend obliquely relative to the central axis of the holding member 80 and have a substantially arc-shaped cross section. The holding member 80 has opposite axial end faces, the corners of which are chamfered to form tapered faces 82.

With this arrangement, the holding member 80 may be heated and then be press-fitted into the first fitting region 31 of the bearing support portion 30. During the press-fitting operation, the inner circumference of the first fitting region 31 may press into the grooves 84m formed in the outer circumferential face 84 of the holding member 80. Because the grooves 84 extend obliquely relative to the central axis of the holding member 80, the holding member 80 rotates about its axis as the holding member 80 is press-fitted into the first fitting region 31.

Therefore, the outer circumferential face 84 of the holding member 80 and the inner circumference of the bearing support portion 30 (more specifically, the first fitting region 31) engage with each other with respect to the axial direction. As a result, the holding member 80 can be reliably prevented from being removed from the bearing support portion 30.

In place of the holding member 80 having the grooves 84m in the outer circumferential face 84, a holding member 90 shown in FIGS. 9(A) and 9(B) may be used. The holding member 90 has through holes 94h formed in the holding member 90 to extend therethrough in the diametrical direction (from an outer circumferential face 94 to an inner circumferential face 93). Also with this holding member 90, during the press-fitting operation, the inner circumference of the first fitting region 31 may press into the thorough holes 94h, and therefore, it is possible to reliable prevent the holding member 90 from being removed. Also, the holding member 90 has opposite axial end faces, the corners of which are chamfered to form tapered faces 92.

According to this embodiment and its alternative embodiment, no radial projection is formed on the outer circumferential face 84(94) of the holding member 80(90). Therefore, the holding member 80(90) can be smoothly press-fitted into the bearing support portion 30.

The present invention may not be limited to the above embodiments but may be modified in various ways. For example, although the holding member 50 of the embodiment shown in FIGS. 1, 2, 3(A), 3(B) and 3(C) has the projecting portion 52, the V-shaped recess portion 53, the concave-convex portion 54 and the corner recess portion 55 on the outer circumference, the projecting portion 52 and the V-shaped recess portion 53 can be omitted. In addition, although the concave-convex portion 54 has the ridges 54s arranged like gear teeth, the width of the trough between each two adjacent ridges 54s may be increased. Further, although the holding member 50 is heated before it is press-fitted into the first fitting region 31 of the bearing support member 30, the holding member 50 can be press-fitted at a normal temperature without being heated. Further, the concave-convex portion 54 may be simply formed by a plurality of linear projections.

Although the holding member 60(64) of the embodiment shown in FIGS. 4(A) to 4(D) and 5 has no concave or convex portion on the outer circumferential face, it is possible to form a concave-convex portion with saw teeth-like configuration. Further, although the holding member 64 has an arc-shaped configuration, the holding member 64 may have a ring-shaped configuration having an outer diameter smaller than the inner diameter of the first fitting region 31 of the bearing support portion 30.

Although the clamp member 70(A)(70(B)) of the embodiment shown in FIGS. 6(A) to 6(D) and 7(A) and 7(B) has a cylindrical configuration, it may have a spiral configuration and may be formed of a leaf spring. It is also possible to use a pair of arc-shaped plates and screws. The arc-shaped plates may be positioned to surround the outer circumference of the bearing support portion 30 from opposite sides. The screws may fix the opposite circumferential ends of the arc-shaped plates relative to each other.

Further, although the bearing 15 is press-fitted into the second fitting region 35 of the bearing support portion 30 in the above embodiments, the bearing 15 may be fitted into the second fitting region 35 by using any other processes than the press-fitting process.

Although the grooves 84m of the holding member 80 have an arc-shaped cross section in the embodiment shown in FIG. 8, the cross sectional configuration of the grooves 84m can be changed. In addition, the number of the grooves 84m can be suitable determined. Although the through-holes 94h of the holding member 90 of the embodiment shown in FIGS. 9(A) and 9(B) have a circular cross section, the cross sectional configuration of the through holes 94h may be changed. In addition, the through holes 94h may be replaced with bottomed radial holes. The number of the through holes 94h or the bottomed holes can be changed.

Further, although the above embodiments have been described in connection with bearing fixing structures for supporting the shaft portions 16 of the throttle valve 18 of the throttle control device 10, the present invention also may be applied to bearing fixing structures for any other rotary machines and apparatus.

This invention claims:

1. A structure for fixing a bearing in position within a resin housing, the bearing being fitted into an inner circumference of the housing, the structure comprising:
an annular holding member constructed to be press-fitted into the inner circumference of the housing so as to hold the bearing from one side with respect to an axial direction of the housing for preventing the bearing from being removed from the housing; and
an engaging device constructed to engage an outer circumferential face of the holding member with the inner circumference of the housing with respect to the axial direction of the housing.

2. The structure as in claim 1,
wherein the engaging device comprises at least one convex portion provided on the outer circumferential face of the holding member; and
wherein the at least one convex portion can press into the inner circumference of the housing.

3. The structure as in claim 2, wherein the at least one convex portion comprises a plurality of ridges extending obliquely relative to a central axis of the holding member and arranged in a circumferential direction of the holding member.

4. The structure as in claim 1,
wherein the engaging device comprises at least one concave portion provided on the outer circumferential face of the holding member, and
wherein the inner circumference of the housing can press into the at least one concave portion.

5. The structure as in claim 4, wherein the at least one concave portion comprises a plurality of grooves formed in the outer circumferential face of the holding member, and wherein the plurality of grooves extend obliquely relative to a central axis of the holding member and are arranged in a circumferential direction of the holding member.

6. The structure as in claim 4, wherein the at least one concave portion comprises at least one radial hole extending radially inward from the outer circumferential face of the holding member.

7. A method of fixing a bearing in position within a resin housing, the bearing being fitted into an inner circumference of the housing, the method comprising the steps of:
preparing a holding member having an outer circumferential face and having at least one convex portion or at least one concave portion provided on the outer circumferential face;
heating the holding member;
press-fitting the heated holding member into the inner circumference of the housing and holding the bearing from one side with respect to an axial direction of the housing, so that the inner circumference of the housing is softened by the heat and the at least one convex portion or the at least one concave portion engages the inner circumference of the housing.

8. A method of fixing a bearing in position within a resin housing, the bearing being fitted into an inner circumference of the housing, the method comprising the steps of:
preparing a holding member having an outer diameter and resiliently deformable to vary the outer diameter;
heating the holding member;
forcing the holding member to resiliently reduce the outer diameter and fitting the holding member into the housing, so that the holding member is positioned to hold the bearing from one side with respect to an axial direction of the housing;
permitting the holding member to resiliently enlarge the outer diameter, so that the inner circumference of the housing is softened by the heat of the holding member and the holding member presses into the inner circumference of the housing.

9. A method of fixing a bearing in position within a resin housing, the bearing being fitted into an inner circumference of the housing, the method comprising the steps of:
preparing a holding member having an arc-shaped configuration and having an outer diameter smaller than a diameter of the inner circumference of the housing;
heating the holding member;
fitting the holding member into the housing, so that the holding member is positioned to hold the bearing from one side with respect to an axial direction of the housing;
moving the holding member in a direction radially outward with respect to the housing, so that the inner circumference of the housing is softened by the heat of the holding member and the holding member presses into the inner circumference of the housing.

10. A structure for fixing a bearing in position within a resin housing, the bearing being fitted into an inner circumference of the housing, the structure comprising:
a clamp member constructed to clamp the housing in such a direction that a diameter of the inner circumference of the housing is reduced, so that the bearing is prevented from being removed from the housing.

11. The structure as in claim 10, wherein the housing is opened at one end, and the clamp member is positioned on the side of the one end of the housing with respect to the bearing.

12. The structure as in claim 10, wherein the clamp member is resiliently deformable, so that the clamping member clamps the housing by a resilient force.

13. The structure as in claim 10, wherein clamp member has a tubular configuration having an inner diameter smaller than a diameter of an outer circumference of the housing, and wherein the clamp member is fitted onto the housing, so that the clamp member clamps the outer circumference of the housing from the outer side.
